(19) United States
(12) Patent Application Publication
(10) Pub. No.: US 2014/0028636 A1
(43) Pub. Date: Jan. 30, 2014

(54) MULTI-FUNCTION STYLUS

(71) Applicants: FIH (Hong Kong) Limited, Kowloon (HK); SHENZHEN FUTAIHONG PRECISION INDUSTRY CO., LTD., Shenzhen (CN)

(72) Inventors: YONG-GANG ZHANG, Shenzhen (CN); KUAN-HUNG CHEN, Shindian (TW)

(21) Appl. No.: 13/915,786

(22) Filed: Jun. 12, 2013

(30) Foreign Application Priority Data
Jul. 30, 2012 (CN) 2012102657926

(51) Int. Cl. G06F 3/033

(52) U.S. Cl. CPC G06F 3/033
USPC 345/179

(57) ABSTRACT

A multi-function stylus includes a sleeve, a holder and a pen. The sleeve defines a cavity and has a connecting member at one end. The holder includes a first magnet and a second magnet at opposite ends thereof. The pen is threadedly connected to the holder. The connecting member is attracted by the first magnet or the second magnet, for connecting the sleeve to the holder or the pen.

BACKGROUND

1. Technical field

The disclosure generally relates to styluses, and particularly to a multi-function stylus.

2. Description of the Related Art

Many electronic devices include styluses for inputting information and selecting menu options. However, such styluses may have no other use besides being used to touch the electronic device. Additionally, the stylus often needs to a pen function. The pen function or the touching function is not easily to be switched.

Therefore, there is room for improvement within the art.

### BRIEF DESCRIPTION OF THE DRAWINGS

Many aspects of an exemplary multi-function stylus can be better understood with reference to the following drawings. The components in the drawings are not necessarily drawn to scale, the emphasis instead being placed upon clearly illustrating the principles of the exemplary multi-function stylus. Moreover, in the drawings, like reference numerals designate corresponding parts throughout the several views. Wherever possible, the same reference numbers are used throughout the drawings to refer to the same or like elements of an embodiment.

FIG. 1 is a partially exploded view of a multi-function stylus including a holder, a pen, and a sleeve according to an exemplary embodiment.

FIG. 2 is an exploded view of the stylus and the pen of the multi-function stylus shown in FIG. 1.

FIG. 3 is a schematic assembled view of the multi-function stylus shown in FIG. 1, shown in a first configuration.

FIG. 4 is similar to FIG. 3, but shown in a second configuration.

### DETAILED DESCRIPTION

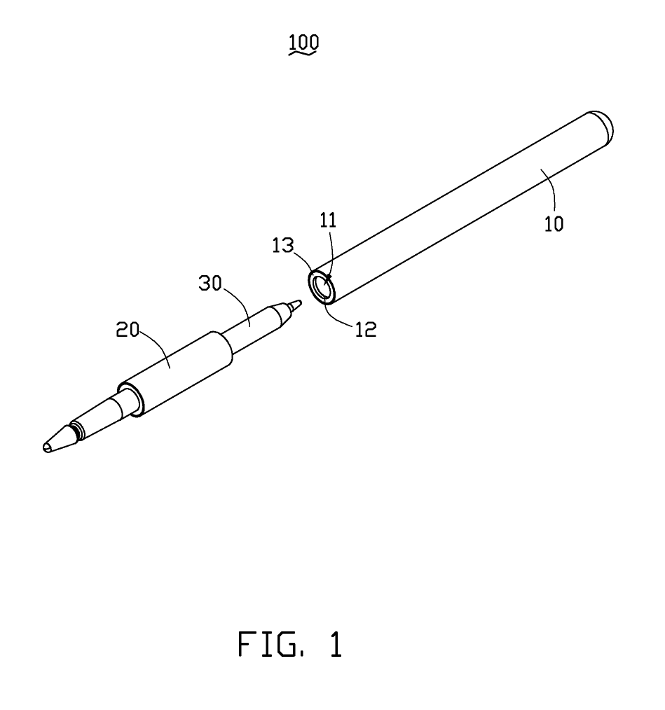

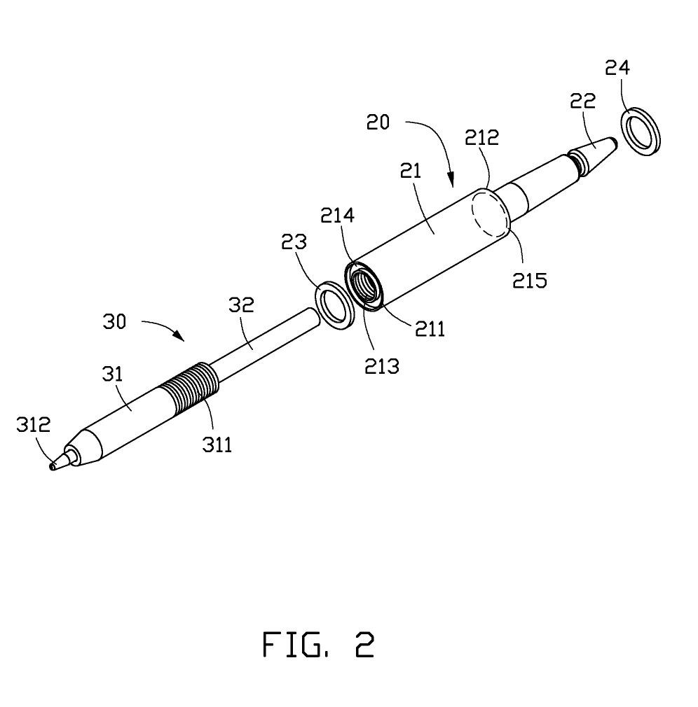

FIGS. 1-2 show a multi-function stylus 100 which can be used to contact a touch screen of an electronic device such as a mobile phone. The multi-function stylus 100 has a sleeve 10, a holder 20, and a pen 30. The holder 20 is detachably attached to the pen 30. The sleeve 10 is fitted around the holder 20 or the pen 30 for holding.

The sleeve 10 is substantially cylindrical and defines a receiving cavity 11. One end of the receiving cavity 11 has an open end 12 which allows the receiving cavity 11 to communicate to outside of the sleeve 10. A connecting member 13 is positioned at the open end 12. In this exemplary embodiment, the connecting member 13 is a ring magnet and is secured on the sleeve 10 by, e.g., adhesive.

The holder 20 has a holder body 21, a stylus head 22 located at one end of the holder body 21, a first magnet 23, and a second magnet 24. The holder body 21 is substantially a hollow cylinder and has a coarse outer surface for gripping. The holder body 21 has a first end 211 and a second end 212. The first end 211 defines a threaded hole 213. An end surface of the first end 211 defines a first latching groove 214, and the second end 212 defines a second latching groove 215. The first latching groove 214 and the second latching groove 215 are ring-shaped. The stylus head 22 is connected to the second end 212. The first magnet 23 and the second magnet 24 are ring-shaped and are respectively mounted in the first latching groove 214 and the second latching groove 215.

The pen 30 is substantially a ballpoint pen and includes a pen body 31 and a pen core 32. The pen body 31 has a threaded portion 311 at one end and a pen head 312 at another opposite end thereof. The threaded portion 311 can be engaged with the threaded hole 213 of the holder 20.

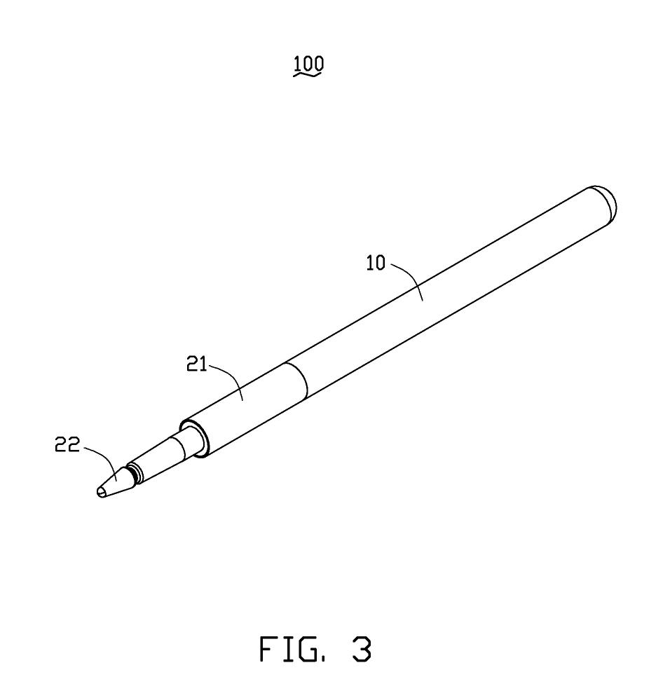

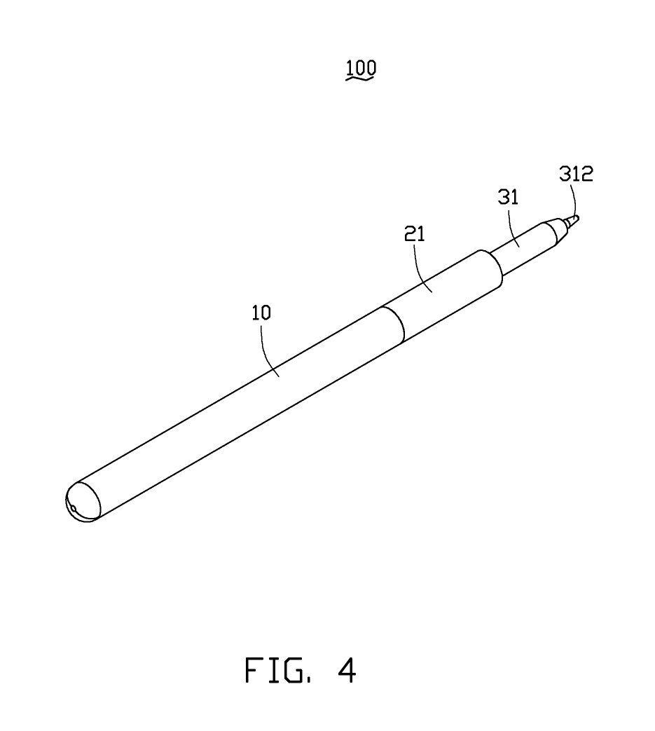

Referring to FIGS. 3-4, in assembly, the threaded portion 311 of the pen 30 is threadedly engaged in the threaded hole 213 of the holder 20 for connecting the pen 30 to the holder 20. The sleeve 10 is fitted around the pen 30 or the holder 20, and the connecting member 13 is attracted by the first magnet 23 or the second magnet 24 to mount the sleeve 10 on the pen 30 or the holder 20.

To use the pen 30, the sleeve 10 is slid to cover the holder 20. To use the stylus head 22, the sleeve 10 is slid to cover the pen 30.

The multi-function stylus 100 can be used on the touch screen or for writing on a medium, and it is easy to use.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A multi-function stylus comprising:
a sleeve defining a cavity and having a connecting member at one end;
a holder comprising a first magnet and a second magnet at opposite ends thereof; and
a pen threadedly connected to the holder;
wherein the connecting member is attracted by the first magnet or the second magnet, for connecting the sleeve to the holder or the pen.

2. The multi-function stylus as claimed in claim 1, wherein the connecting member is a ring magnet and is secured on the sleeve.

3. The multi-function stylus as claimed in claim 2, wherein the sleeve is cylindrical, one end of the receiving cavity has an open end which allows the receiving cavity communicates with an outside of the sleeve, and the connecting member is positioned at the open end.

4. The multi-function stylus as claimed in claim 1, wherein the holder comprises a holder body and a stylus head, the holder body comprises a first end and a second end, the first end defines a first latching groove and the second end defines a second latching groove, and the first magnet and the second magnet are respectively mounted in the first latching groove and the second latching groove.

5. The multi-function stylus as claimed in claim 4, wherein the first end defines a thread hole, the pen has a threaded portion at one end and a pen head at another opposite end thereof, the threaded portion is engaged with the thread hole of the holder for connecting each other.

6. A multi-function stylus comprising:
a sleeve having a connecting member at one end;
a holder comprising a first magnet and a second magnet at opposite ends thereof; and
a pen secured to the holder;
wherein the connecting member is attracted by the first magnet or the second magnet, for connecting the sleeve to the holder or the pen.

7. The multi-function stylus as claimed in claim 6, wherein the holder comprises a holder body and a stylus head, the holder body includes a first end and a second end, the first end defines a first latching groove and the second end defines a second latching groove, and the first magnet and the second magnet are respectively mounted in the first latching groove and the second latching groove.

8. The multi-function stylus as claimed in claim 7, wherein the first end defines a thread hole, the pen has a threaded portion at one end and a pen head at another opposite end thereof, and the threaded portion is engaged with the thread hole of the holder for connecting each other.
